(19) United States
(12) Patent Application Publication
(10) Pub. No.: US 2009/0188459 A1
(43) Pub. Date: Jul. 30, 2009

(54) PROCESS AND SYSTEM FOR STARTING A DIRECT-INJECTING INTERNAL-COMBUSTION ENGINE AS WELL AS MOTOR VEHICLE

(75) Inventors: Marco FLECKNER, Leonberg (DE); Dietmar SCHWARZENTHAL, Ditzingen (DE)

Correspondence Address: CASELLA & HESPOS, 274 MADISON AVENUE, NEW YORK, NY, 10016, US

(73) Assignee: Dr. Ing. h.c. F. Porsche Aktiengesellschaft, Stuttgart (DE)

(21) Appl. No.: 12/239,365

(22) Filed: Sep. 26, 2008

(30) Foreign Application Priority Data
Sep. 29, 2007 (DE) 10 2007 046 819.0

(51) Int. Cl. F02N 17/00; F02N 1/00

(52) U.S. Cl. 123/179.3; 123/185.1

(57) ABSTRACT

A process for starting a direct-injecting internal-combustion engine is disclosed. The process includes triggering a separate drive for adjusting the camshaft for causing an angular position change between the crankshaft and the camshaft until the separate drive rotates the crankshaft such that a working medium is compressed by a piston in a cylinder of the internal-combustion engine. The position of the pistons of the internal-combustion engine is determined by using position determining devices to identify the cylinder of the internal-combustion engine in which the working medium is compressed. Fuel is injected into the cylinder in which the working medium is compressed when the cylinder is in a proximity of an upper dead center to start the internal-combustion engine.

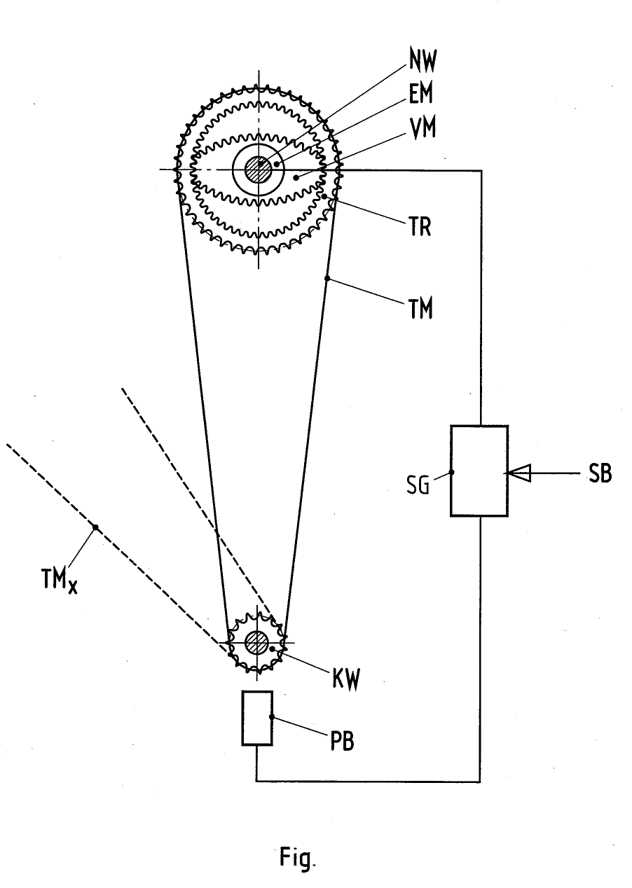

This application claims the priority of German Patent Document No. 10 2007 046 819.0, filed Sep. 29, 2007, the disclosure of which is expressly incorporated by reference herein.

### BACKGROUND AND SUMMARY OF THE INVENTION

The invention relates to a process for staring a direct-injecting internal-combustion engine, to a corresponding system, as well as to a corresponding motor vehicle.

The internal-combustion engine of a motor vehicle is normally started by a starter motor, such as a pinion starter. In the case of hybrid vehicles, thus, in the case of motor vehicles which, in addition to the internal-combustion engine, have at least one additional electric machine, this electric machine can take over the function of the starter motor and the latter can therefore be eliminated.

It is an object of the invention to indicate a further process as well as a corresponding system for starting an internal-combustion engine.

According to the invention, a process for starting a direct-injecting internal-combustion engine comprises at least the following steps. Triggering a separate drive, whereby the crankshaft of the internal-combustion engine, by way of mechanical driving devices, which comprise an adjusting mechanism having the separate drive is provided for driving a camshaft of the internal-combustion engine, for adjusting the camshaft in order to cause by way of the adjusting mechanism an angular-position change between the crankshaft and the camshaft until the separate drive of the adjusting mechanism rotates the crankshaft by way of the mechanical driving devices and thus a working medium is compressed in at least one cylinder of the internal-combustion engine by means of the piston. Then, the process includes determining the position of the pistons by using position determining devices and thus identifying the cylinder of the internal-combustion engine in which the working medium is compressed. Further, the process includes injecting fuel into this cylinder when the cylinder is in the proximity of its upper dead center, for starting the internal-combustion engine. In other words, the invention utilizes the separate drive of a camshaft adjusting device for starting the internal-combustion engine. For this purpose, during a stoppage of the internal-combustion engine, an “inverse” operation of the camshaft adjusting device takes place for a short time in that its separate drive is therefore utilized for driving the crankshaft of the internal-combustion engine by way of the mechanical driving devices. The separate drive of the camshaft adjusting device is therefore quasi reworked as a starter motor. In this case, the camshaft adjusting device adjusts only the control timing of the camshaft with respect to the crankshaft; the valve opening period and the valve stroke of the internal-combustion engine are not changed by this phase adjustment. The invention is based on the recognition that the angular-position change between the crankshaft and the camshaft caused by means of the separate drive, in each case, affects that shaft which has the lower moment of resistance. In the case of the moment of resistance, for example, the friction, the moments of compression for compressing the cylinders or the operating moments of the valves at the camshaft are to be taken into account.

Particularly preferably, the separate drive is triggered in the first step until a cam rests approximately on the stop of a valve of the internal-combustion engine, and is subsequently triggered further, in which case the cam resting on the stop of the valve now supports itself on this valve and thereby blocks the camshaft, whereby the separate drive now rotates the crankshaft by way of the mechanical driving devices. In the case of a corresponding design, this permits a reliable use of the invention.

In a first preferred embodiment of the invention, the internal-combustion engine is provided as a direct-injecting diesel engine, in which case diesel fuel is injected in the proximity of the upper dead center, which diesel fuel ignites itself and the internal-combustion engine is started in this manner.

In a second preferred embodiment, the internal-combustion engine is provided as a direct-injecting Otto engine, in which case Otto fuel is injected in the proximity of the upper dead center and an ignition operation is triggered and the internal-combustion engine is started in this manner. Naturally, the internal-combustion engine may also be provided as a lean-mix engine (stratified-charge or Disotto engine).

Driving belts or toothed belts or a chain drive are provided as particularly reliable mechanical driving devices. These permit a low-maintenance drive of the camshaft by way of the mechanical driving device by the crankshaft of the internal-combustion engine, and thereby also the start of the internal-combustion engine according to the invention.

In this case, the driven camshaft may be provided as an inlet or outlet camshaft of the internal-combustion engine. As a function of the type of internal-combustion engine, a flexible use of the invention is thereby obtained.

Crankshaft sensors were found to be successful as the position determining devices. By way of corresponding projections or notches of the crankshaft, reliable conclusions can then be drawn about the position of the crankshaft and thus about the power cycle of the individual cylinders of the internal-combustion engine. In particular, it can also be determined when a cylinder is situated in the proximity of its upper dead center in order to thus provide an injection of fuel for starting the internal-combustion engine.

In a preferred embodiment, the separately drivable adjusting mechanism comprises a transmission, especially a planetary transmission. When the space requirements are low, a sufficient torque can also be applied in the case of a separate drive with a relatively low-power design in that a corresponding transmission ratio is used.

Particularly preferably, the separate drive of the adjusting mechanism is implemented electrically, particularly as an electric motor. Naturally, other types of drives may also be provided, such as an electro-hydraulic drive. In each case, a reliable operation of the separate drive is necessary when the internal-combustion engine is idle.

The process according to the invention utilizes the separately drivable adjusting mechanism for rotating the crankshaft. However, normally only a limited adjusting range is provided in order to protect the valves of the internal-combustion engine. As a result, it is advantageous to move the separately drivable adjusting mechanism into an end stop position when the internal-combustion engine is switched off. The reason is that, when the internal-combustion engine is started, according to the process of the invention, the entire adjusting range of the separately drivable adjusting mechanism will be available. In this case, the forward or rearward end stop of the separately drivable adjusting mechanism can be provided as end stop positions. In other words, as a result of the process according to the invention, the engine can be started in the forward or backward direction.

In a particularly preferred embodiment of the invention, the internal-combustion engine is constructed as a multi-bank engine with respectively assigned, separately driven adjusting mechanisms, the adjusting mechanisms being controlled in the same direction, for the addition of the torques transmitted by the separate drives—supported, for example, at the respective valves—by way of the mechanical driving devices to the crankshaft. The addition of the torques may be provided successively or simultaneously. With each triggered separate drive of a respective adjusting mechanism of a camshaft, the torque is increased that is transmitted to the crankshaft by way of the mechanical driving devices. As a result, also the torques for the rotation of the crankshaft are correspondingly increased and a reliable start of the internal-combustion is ensured.

In this case, the adjusting mechanism may also comprise a torque support which ensures a supporting, for example, in the direction opposite to the rotating direction, and thus the rotation of the crankshaft. For this purpose, for example, a free wheel may be provided on the camshaft or the crankshaft.

### BRIEF DESCRIPTION OF THE DRAWING

The single FIGURE shows an electric camshaft adjusting device as an example, which is particularly suitable for implementing the process according to the invention.

### DETAILED DESCRIPTION OF THE DRAWING

The crankshaft KW of an internal-combustion engine is schematically illustrated to which a camshaft NW is linked by way of a driving/toothed belt or a chain drive TM, for transmitting a rotating movement between the crankshaft KW and the camshaft NW. In this case, the internal-combustion engine is a direct-injecting Diesel or Otto engine. Additional driving/toothed belts or belt drives TMx may be provided at the crankshaft KW, for linking additional camshafts of the internal-combustion engine. This is schematically illustrated in the FIGURE by a broken line.

The driving/toothed belt or chain drive TM is part of a mechanical driving device for driving the camshaft NW and linked to a separately drivable adjusting mechanism. In addition, the mechanical driving device comprises a planetary transmission having a ring gear TR driven by a driving/toothed belt or chain drive TM. Furthermore, the planetary transmission comprises a (not shown) sun gear to which the camshaft NW is linked. Then a planet carrier VM is provided for connecting the ring gear TR with the sun gear. A separate drive in the form of an electric motor EM is coupled to the planet carrier. The electric motor EM is used for adjusting the camshaft NW within a certain angular range. Irrespective thereof, the camshaft NW is constantly rotated by the crankshaft KW by way of the driving/toothed belt or chain drive TM when the internal-combustion engine is operative.

For protecting the valves of the internal-combustion engine assigned to the camshaft NW, the adjusting mechanism, that is, the angular range in which the camshaft NW can be adjusted, is limited. For example, an adjusting range of 70° of the camshaft is customary. So that the ratio of the planetary transmission can be effective, the internal-combustion engine is started within the adjusting range of the camshaft adjusting device. For this reason, the camshaft adjusting device is moved into the end stop position when the internal-combustion engine is being switched off. For starting the internal-combustion engine, the electric camshaft adjustment is triggered which can transmit a torque from the electric motor EM by way of the mechanical driving devices to the crankshaft KW. The triggering causes an angular position change between the camshaft NW and the crankshaft KW. The adjustment takes place with the torque of the ratio of the planetary transmission, for example, a ratio of 1:60. Summarizing, this (as a result of the ratio of 1:2 between the crankshaft and the camshaft in the case of a four-cycle engine) leads to a ratio of 1:30. Thus, the differential rotational speed at the ring gear causes an adjustment of the crankshaft.

By triggering the electric motor EM, the planet carrier of the planetary transmission is therefore rotated. This rotating movement is transmitted to the sun gear and rotates the camshaft NW. Because the force for operating a valve of the internal-combustion engine is greater than the force for rotating the crankshaft KW, the electric motor EM now supports itself on the valve or on the valve spring supporting the latter, whereby the crankshaft KW is rotated by the electric motor EM of the electric camshaft adjusting device. The reason is that the cam resting against this blocking valve is supported on the valve spring and blocks the camshaft. In that, in the case of the planetary transmission, the sun gear connected with the camshaft is now blocking but the electric motor EM continues to drive the planetary transmission, the ring gear TR is now rotated by the electric motor EM. The rotating movement of the ring gear is transmitted by way of the driving/toothed belt or the chain drive TM to the crankshaft KW of the internal-combustion engine; for the moment of resistance at the camshaft NW is now greater than the moment of resistance at the crankshaft KW, whereby the crankshaft KW starts to move. As a result of the movement of the crankshaft KW, the working medium is now compressed in at least one cylinder space of the internal-combustion engine by the movement of the piston.

The position of the crankshaft KW is continuously determined by way of the crankshaft sensor PB of the internal-combustion engine. For this purpose, the indentations and elevations respectively placed at the defined points of the crankshaft KW are sensed and in this manner, by way of the position of the crankshaft, conclusions are drawn concerning the position of the pistons in the individual cylinders of the internal-combustion engine. It can thereby be determined in which of the cylinders of the internal-combustion engine the working medium is compressed by the rotation of the crankshaft KW. In the proximity of the upper dead center of the cylinder in which the working medium is maximally compressed, fuel is now injected and the internal-combustion engine is started in this fashion. In this case, the controlling of the starting operation according to the invention takes place by way of a control device SG, the starting operation of the internal-combustion engine being initiated by the control device SG upon receiving a starting command SB.

The starting operation according to the invention of a direct-injecting internal-combustion engine is particularly suitable for a use in vehicles having a start-stop system and in hybrid vehicles. When a starting operation according to the invention is provided in the case of vehicles having a start-stop system while the internal-combustion engine is in a hot-running condition, a conventional starter motor only still has to be provided for cold starts. As a result, the conventional starter motor can be designed for correspondingly fewer starting operations or, as required, can even be completely eliminated. In the case of hybrid vehicles, particularly in the case of a parallel full hybrid having an electric machine which is linked to the internal-combustion engine by way of a clutch and can be operated as a motor or a generator, an expanded electric driving range is conceivable. The reason is that no more torque reserve has to be provided at the electric machine for restarting the internal-combustion engine. In addition, there is an improvement in comfort during the restart.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A process for starting a direct-injecting internal-combustion engine, a crankshaft (KW) of the internal-combustion engine, by way of mechanical driving devices (TM, TR), being provided for driving a camshaft (NW) of the internal-combustion engine, the mechanical driving devices comprising an adjusting mechanism having a separate drive (EM) for adjusting the camshaft for causing an angular position change between the crankshaft and the camshaft, and position determining devices (PB) being provided for determining a position of pistons of cylinders of the internal-combustion engine;
wherein the process comprises the steps of:
triggering the separate drive for causing, by way of the adjusting mechanism, the angular position change between the crankshaft and the camshaft until the separate drive rotates the crankshaft by way of the mechanical driving devices, and thus, a working medium is compressed by a piston in a cylinder of the internal-combustion engine;
determining the position of the pistons of the internal-combustion engine by using the position determining devices, and thus, identifying the cylinder of the internal-combustion engine in which the working medium is compressed; and
injecting of fuel into the cylinder in which the working medium is compressed when the cylinder is in a proximity of an upper dead center, for starting the internal-combustion engine.

2. The process according to claim 1, wherein, in the triggering step, the separate drive is triggered until a cam rests approximately on an end stop of a valve of the internal-combustion engine, and is subsequently further controlled, wherein the cam resting on the end stop of the valve is now supported at this valve and thereby blocks the camshaft, wherein the separate drive now rotates the crankshaft by way of the mechanical driving devices.

3. The process according to claim 1, wherein the internal-combustion engine is constructed as a direct-injecting diesel engine, whereby diesel fuel is injected in the proximity of the upper dead center, which diesel fuel ignites itself, and the internal-combustion engine is started in this manner.

4. The process according to claim 1, wherein the internal-combustion engine is constructed as a direct-injecting Otto engine, wherein Otto fuel is injected in the proximity of the upper dead center and an ignition operation is triggered to start the internal-combustion engine.

5. The process according to claim 1, wherein, when the internal-combustion engine is being switched off, the adjusting mechanism is moved into an end stop position by the separate drive.

6. The process according to claim 5, wherein the end stop position is provided as a forward end stop position for starting the internal-combustion engine by rotating the crankshaft beyond the upper dead center of a cylinder, or as a rearward end stop position for starting the internal-combustion engine by rotating the crankshaft against a running direction of the internal-combustion engine.

7. The process according to claim 1, wherein the internal-combustion engine is constructed as a multi-bank engine, having adjusting mechanisms in each case assigned to the camshafts and having respective separate drives, wherein the respective adjusting mechanisms are controlled in a same direction, for an addition of torques transmitted from the separate drives by way of respective mechanical driving devices to the crankshaft.

8. A system for starting a direct-injecting internal-combustion engine, the crankshaft (KW) of the internal-combustion engine, by way of mechanical driving devices (TM, TR), being provided for driving a camshaft (NW) of the internal-combustion engine, the mechanical driving devices comprising an adjusting mechanism having a separate drive (EM) for adjusting the camshaft for causing an angular position change between the crankshaft and the camshaft, and position determining devices (PB) being provided for determining a position of pistons of cylinders of the internal-combustion engine;
wherein a control unit is provided comprising:
detection devices for detecting a start-related signal for the internal-combustion engine;
triggering devices for triggering the separate drive for causing, by way of the adjusting mechanism, the angular position change between the crankshaft and the camshaft until the separate drive rotates the crankshaft by way of the mechanical driving devices, and thus, a working medium is compressed by a piston in a cylinder of the internal-combustion engine;
determining devices for determining the position of the pistons of the internal-combustion engine by using the determining devices in order to thereby identify the cylinder of the internal-combustion engine in which the working medium is compressed; and
output devices for output of a command for starting the internal-combustion engine by injecting fuel into the cylinder of the internal-combustion engine in which the working medium is compressed when the cylinder is in a proximity of an upper dead center, for starting the internal-combustion engine.

9. The system according to claim 8, wherein the mechanical driving devices comprise a driving/toothed belt or a chain drive for transmitting a rotating movement between the crankshaft and the camshaft.

10. The system according to claim 8, wherein the camshaft is constructed as an inlet or outlet camshaft for operating inlet or outlet cams of the internal-combustion engine.

11. The system according to claim 8, wherein the determining devices are constructed as crankshaft sensors in order to be able to determine the position of the pistons of cylinders of the internal-combustion engine.

12. The system according to claim 8, wherein a transmission is assigned to the separate drive in order to cause a relative movement between the camshaft and the mechanical driving devices and, as a result, the camshaft is adjusted by triggering the separate drive.

13. The system according to claim 12, wherein the transmission is a planetary transmission.

14. The system according to claim 8, wherein the separate drive is an electric motor.

15. The system according to claim 8, wherein the separate drive has a torque support in certain load conditions in order to ensure the rotation of the crankshaft.

16. The system according to claim 15, wherein the torque support is provided as a free wheel in a direction opposite to a rotating direction on the camshaft and/or the crankshaft.

17. A motor vehicle having a system according to claim 8.

18. The motor vehicle according to claim 17, wherein the motor vehicle is provided as a parallel full hybrid having an electric machine linked by way of a clutch to the internal-combustion engine and operable as a motor or a generator.
